(19) United States
(12) Patent Application Publication
(10) Pub. No.: US 2026/0172574 A1
(43) Pub. Date: Jun. 18, 2026

(54) ENTROPY ADAPTATION FOR DEEP FEATURE COMPRESSION USING FLEXIBLE NETWORKS

(71) Applicant: INTERDIGITAL CE PATENT HOLDINGS, SAS, Paris (FR)

(72) Inventors: Francois SCHNITZLER, Saint Avé (FR); Stephane ONNO, Saint Gregoire (FR); Anne LAMBERT, Saint-Aubin-d’Aubigné (FR); Pierre HELLIER, Thorigne-Fouillard (FR)

(21) Appl. No.: 19/126,909

(22) PCT Filed: Oct. 24, 2023
(86) PCT No.: PCT/EP2023/079573

§ 371 Date: May 2, 2025

(30) Foreign Application Priority Data
Nov. 4, 2022 (EP) 22306666.3

(51) Int. Cl. H04N 19/159; H04N 19/44

(52) U.S. Cl. CPC H04N 19/159; H04N 19/44

(57) ABSTRACT

Flexible neural architectures for end-to-end compression are used for image or video compression. In one embodiment, a first device is an encoder, and a second device is a decoder. Transmission of compressed features is performed between the first device and the second device. Mapping of probability tables is performed in the first and second devices. In one embodiment, mapping is communicated between the first and second devices by updating a bitstream used to encode features. In another embodiment, inference is split between user equipment and a network.

### CROSS REFERENCE TO RELATED APPLICATION

This application claims the benefit of European Application Serial No. 22306666.3, filed Nov. 4, 2022, which is incorporated by reference herein in its entirety.

### TECHNICAL FIELD

At least one of the present embodiments generally relates to a method or an apparatus for compression of images and videos using Neural Network based tools.

### BACKGROUND

Compared to classical approaches, Machine Learning (ML) has emerged as a new tool to disrupt compression. The main idea is to learn the entire compression chain, including content description, quantization, entropy coding and descriptor decompression. Deep neural networks (DNN) can be used for such compression.

### SUMMARY

At least one of the present embodiments generally relates to a method or an apparatus in the context of the compression of images and videos using flexible neural architectures. In particular, one objective of the described embodiments is to give a device the flexibility to choose the probability distributions it uses for the entropy coder when using flexible networks. This allows each device to optimize the tradeoff between encoding complexity and coding efficiency based on its specific constraints.

According to a first aspect, there is provided a method. The method comprises steps for determining a probability table mapping by a first neural device based on constraints for an image; communicating said probability table mapping to a second neural device; retrieving an associated probability table based on a configuration by the first neural device; encoding features of the first neural device based on the associated probability table; sending said encoded features to the second neural device; and, reevaluating the configuration of the first neural device.

According to a second aspect, there is provided a method. The method comprises steps receiving probability table mapping from a first neural device; receiving encoded features from the first neural device; and, decoding by a second device said encoded features using said received probability table mapping to generate an image.

According to another aspect, there is provided an apparatus. The apparatus comprises a processor. The processor can be configured to implement the general aspects by executing any of the described methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

According to another general aspect of at least one embodiment, there is provided a non-transitory computer readable medium containing data content comprising instructions to perform any of the encoding or decoding methods.

### BRIEF DESCRIPTION OF THE DRAWINGS

FIG. 1 illustrates a deep neural network (DNN).

FIG. 2 illustrates an example of a split inference of a neural network.

FIG. 3 illustrates a flexible neural network with two layers.

FIG. 4 illustrates an example of mapping selection in a flexible network.

FIG. 5 illustrates examples of mapping used to select probability tables.

FIG. 6 illustrates an example of using one embodiment of the general described aspects.

FIG. 7 illustrates examples of communication of a mapping to devices.

FIG. 8 illustrates one embodiment of the described aspects where the data source comes from a UE.

FIG. 9 illustrates another example of an embodiment of the described aspects where inference is split between the UE (User Equipment) and the network.

FIG. 10 illustrates one embodiment of a method for encoding video using the described embodiments.

FIG. 11 illustrates one embodiment of a method for decoding video using the described embodiments.

FIG. 12 illustrates one embodiment of an apparatus for encoding or decoding using the described embodiments.

FIG. 13 illustrates a standard, generic video compression scheme.

FIG. 14 illustrates a standard, generic video decompression scheme.

FIG. 15 illustrates a processor-based system for encoding/decoding under the general described aspects.

### DETAILED DESCRIPTION

The context of the described embodiments is the compression of image/video content. One goal of the described aspects is to develop new approaches for end-to-end neural compression. While not standardized yet, MPEG is exploring these technologies.

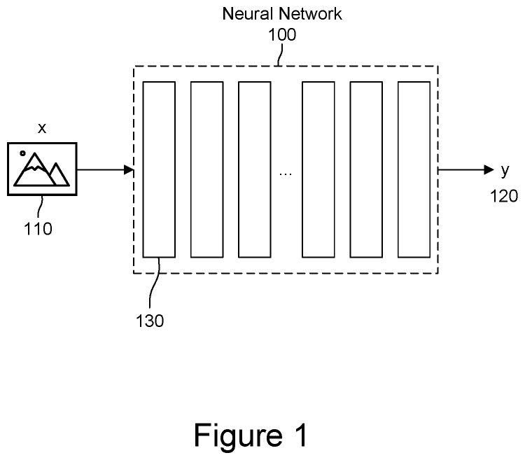

FIG. 1 illustrates a deep neural network. A deep neural network (100) is composed of multiple neural layers such as convolutional layers. In the figure, (130) is the first layer of the neural network. Each neural layer can be described as a function that first multiplies the input by a tensor, adds values called the biases and then applies a nonlinear function on the resulting values. The shape (and other characteristics) of the tensor and the type of non-linear functions are called the architecture of the network. We denote the values of the tensor and the bias by the term “weights”. The weights and, if applicable, the parameters of the non-linear functions, are called the parameters. The architecture and the parameters define a “model”.

Typically, a model M is trained on a database D of images to learn its weights. In supervised learning, this database contains input/output pairs (x, y) and the model M is a function that tries to predict an output (120) from the input (110): M_{θ}(x)=ŷ. Typically, the weights are optimized to minimize a training loss

$${L}_{T} ( M , D ) = {E}_{i \sim D} [ d ( o , \hat{o} ) ] ,$$

where d measures a difference between the real and predicted output. As an example, d can be the square error or the Euclidian distance. The loss function can also contain additional terms, such as regularization terms. Using the trained model is called inference.

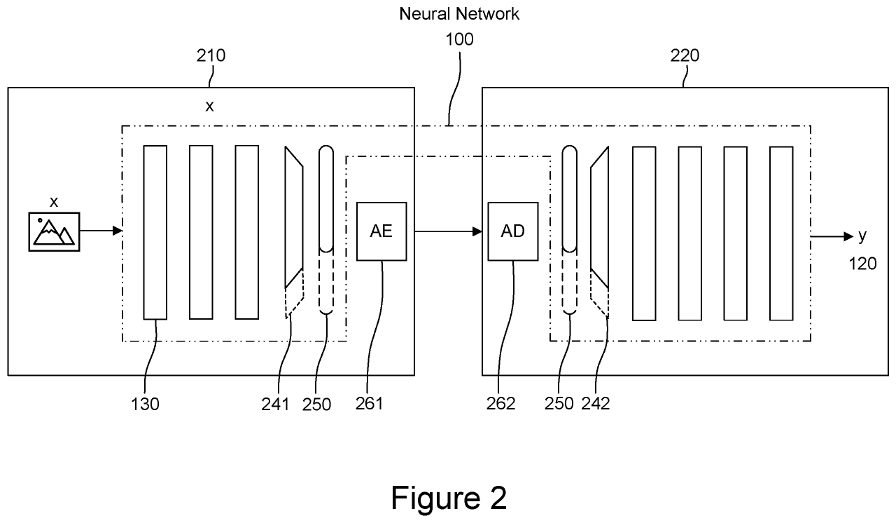

Some neural networks are too large or computationally expensive for inference to be performed in a mobile device. To alleviate this issue, split inference can be performed. This is illustrated in FIG. 2. A neural network (100) is split into two parts. The first part runs on the mobile device (210), and the second part is run by another, more powerful device (220). The intermediate features (250) of the neural network, that is the values computed at the split point of the network, must therefore be transmitted from the first device to the second device.

The size of those intermediate features might be huge. To transmit them, they can be compressed to reduce their size. Several compression methods have been developed to compress those features. Those features can for example be quantized or compressed by auto encoder-like neural network layers. The latter is illustrated in FIG. 2. The first part (241) of the autoencoder lossily compresses the output of the first part of the layer into features. The compressed features are then losslessly compressed, typically using an entropy coding method such as an arithmetic encoder (261). Such an encoder uses a probability distribution over the values to be encoding. On the second device, the corresponding decoder (262) and the second part (242) of the auto-encoder decompress the features. As the bandwidth of the transmission channel may change over time, the compression ratio might need to be adapted during operation. This may be done at the autoencoder level by using a so-called flexible autoencoder. Flexible models are specially designed such that their computational characteristics can be modified on the fly. Many designs exist for flexible networks, including designs that vary the size or quantization levels of intermediate features.

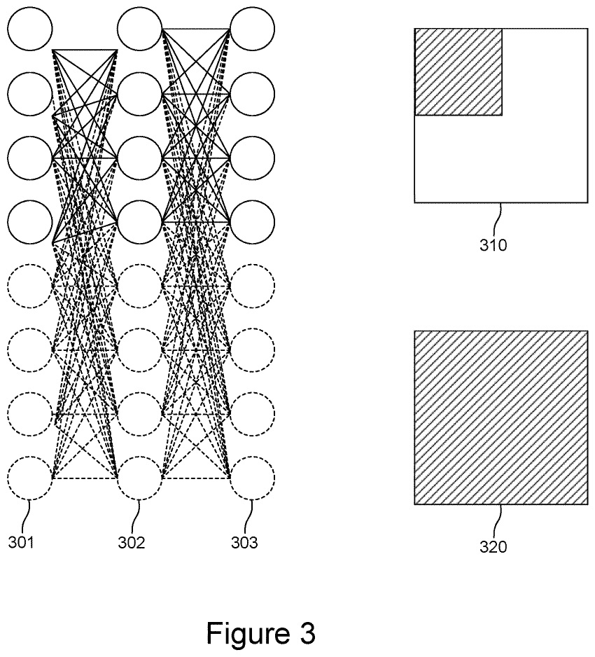

FIG. 3 illustrates a flexible neural network with 2 layers, from left to right. This flexible neural network is called a “slimmable” network. Flexibility is implemented by modifying the number of neurons of the layers—and thus the size of the inputs/outputs. Circles represent values: input values (301), one set of intermediate values (302) and output values (303). Lines represent dependencies between successive layers in the sense that a line connecting two values indicate that the right most value is computed using the left most value. In other words, a line between 2 values indicates that the corresponding weight is nonzero. in this illustration, the flexible network has two modes of operation. In the first mode, only elements with a full line are used: the network uses only the first half of the input, computes only half of the output and uses only ¼ of the weights. The corresponding weight matrix (310) can thus be seen as a matrix where ¾ of the elements are set to zero (white) and ¼ are kept (dashed part of the matrix). In the second mode all comments are used (both full and dashed): all the input is used, all the output is computed and all weights are used. The corresponding matrix uses all the weights (320). Thus, this network offers a trade-off between computation and information computed from the input.

When lossily compressing features transmitted by changing the size of the feature vectors, some weights are set to zero even in the neurons that are kept, leading to a change in the values of the feature vector. Therefore, the distribution of the values of this vector also changes. Encoding this feature vector using an entropic coder based on a single probability distribution over the values of this vector leads to suboptimal encoding. Thus, a different entropy distribution is used for each configuration of the flexible network [1]. For example, one probability table (or set of probability tables) tₖ∈{t₁, . . . , t_{K}} is used for each configuration k∈{1, . . . , K} of the flexible network.

Split inference is typically used when a device does not have enough processing power for the whole network. Changing the distribution used by the entropy coder repeatedly might be a burden on such a device. This problem would be even stronger when the entropy distribution is not encoded in a probability table but is computed dynamically by another neural network.

In the general aspects described, it is proposed:
1. To give a device the flexibility to choose the probability distributions it uses for the entropy coder when using flexible networks. This allows each device to optimize the tradeoff between encoding complexity and coding efficiency based on its specific constraints.
2. An embodiment where one device encodes its choices in the bitstream directly.
3. Another embodiment allowing two devices to synchronize the probability distributions they are using to encode the feature vector when each of those devices performs the computation of one part of the neural network and the features are transmitted from one device to the other.

The key idea of these aspects is to give a device the possibility to choose the probability distributions it uses at any time for the entropy coding when using flexible networks in neural network systems. For clarity, we limit the description to the case of slimmable autoencoder networks unless otherwise specified. However, it should be understood that the described embodiments apply to any other type of flexible neural network used in split inference.

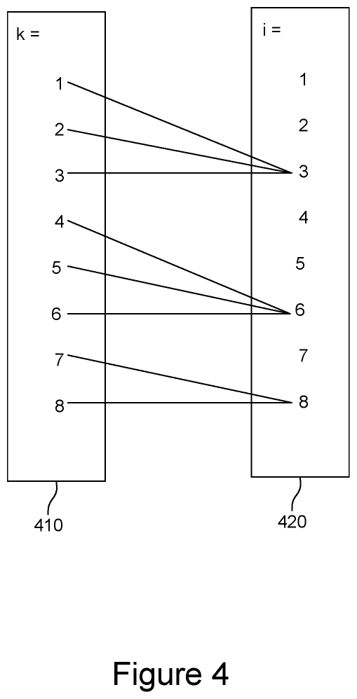

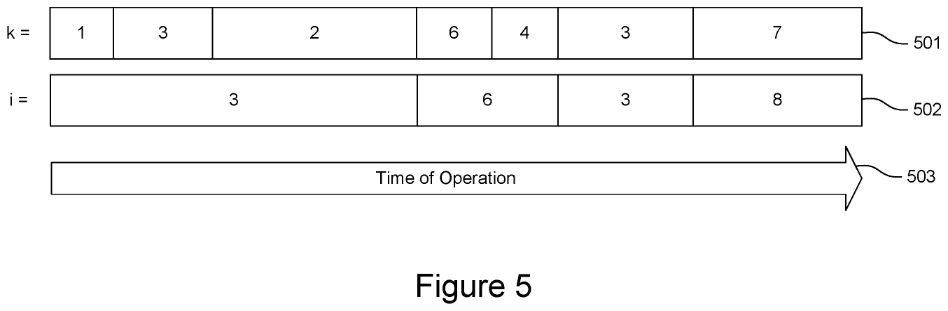

Rather than using the associated probability table tₖ∈{t₁, . . . , t_{K}} for each configuration k∈{1, . . . , K} of the flexible network, we propose that the first device selects a mapping f(k): {1, . . . , K}→S, where S is a subset of {t₁, . . . , t_{K}}. This is illustrated in FIG. 4. To each configuration k of the network (410) is associated a table index i (420). According to this example mapping, table tᵢ is used for configuration k, for example t₃ is used for configurations 1, 2 and 3. This mapping is freely selected by the device based on its constraints, for example limited computational power, memory, or energy. FIG. 5 illustrates how this mapping is then used during operation to select the probability table used for the encoder. FIG. 5 illustrates changes during the operation of the device. At any point in time (503), the device uses one configuration of the flexible network (501), and the probability table defined by the mapping of FIG. 4 (502). Here, the device has changed the configuration used by the flexible network six times during operation. However, thanks to the general aspects described, only 3 changes of the probability tables have been done. This illustrates how the general aspects reduce the number of changes in the encoder and thus simplifies it. The trade-off is a larger bitrate, as the coding is less efficient. For devices with low computational power, such as devices where split inference is likely to be used, the trade-off might be interesting.

Not all mappings are trivially possible. A table mapped to a configuration must define a probability distribution over at least the output domain of the configuration. For example, for the case of slimmable auto-encoders, a probability distribution tₖ defines a probability distribution over the Nₖ first elements of the feature vector, where Nₖ is the number of elements of the feature vector generated by configuration k. This probability table can thus be used for any configuration k′ generating fewer elements of the feature vector. If this probability table contains independent probability distributions for each element of the feature vector, adaptation is trivially done by discarding the Nₖ−Nₖ, elements that are not used. In other cases, any probability table can be adapted by marginalizing¹ it to the Nₖ, elements of the feature vectors. ¹ https://en.wikipedia.org/wiki/Marginal_distribution

On the other hand, mapping table t_{k′} to configuration k, for k′<k, is less straightforward, as t_{k′} does not contain any information over the probability distribution of the Nₖ−N_{k′} element of the feature vector not generated in configuration k′. To allow such a mapping, one mut define a mechanism to generate a probability distribution over these Nₖ−N_{k′} elements. Possible examples include using a given probably distribution, such as the uniform probability distribution or marginalizing tₖ. The latter might involve significant computing cost. That mechanism should be known to both devices. While probably less efficient in terms of coding efficiency, especially when using a uniform probability distribution, such mappings have the advantage of capping the memory required for the largest configuration of the flexible network.

To give another example, consider cases where the flexibility in the auto-encoder results in different quantization levels of the features for different configuration, and a configuration k results in more bits used than k′. Then, table tₖ can easily be used for configuration k′, for example by marginalizing out values that are no longer used, or by assigning to a given value v in the more quantized space (configuration k′) the probability mass of all values of the less quantized space (configuration k) that would be rounded to v. That mechanism should be known to both devices.

For some neural networks, the values of the probability tables used for encoding some or all elements of the features are not static but are dynamically computed by a neural network or part of a neural network. This network can also be flexible. Without the generally described aspects, such a flexible network is controlled by the same index k as the other part of the network. The described embodiments can be used in this context as well and consists in using a different configuration for this table generating network than for the other part of the network. For simplicity, will denote this network by Nₖ when it uses configuration k. A dynamically generated table can be marginalized exactly like a static table. A point of attention is that some inputs of Nₖ might not be generated if k′<k, where k′ denotes the configuration of the main network. Several solutions are possible, such as filling the missing values with an agreed upon value, filling each missing value by its average value, by its last value, by a weighted average of some last values or by an interpolation of these last values.

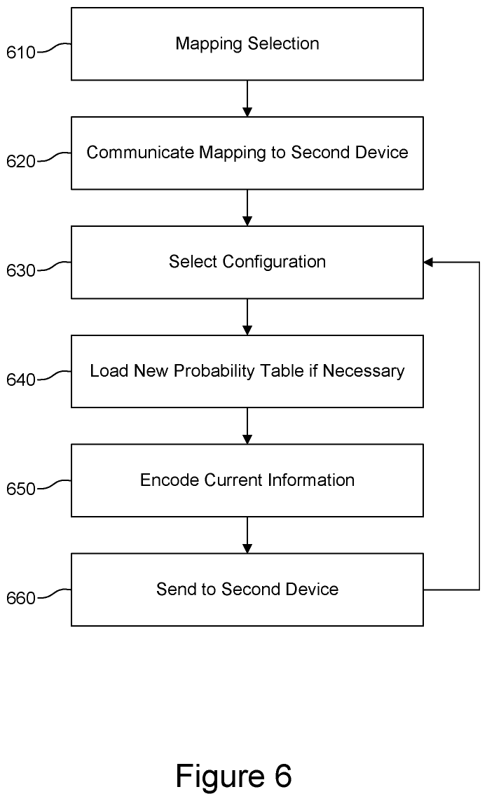

FIG. 6 illustrates how the described embodiments are used in practice. First, the first device selects the mapping (610) by optimizing it for its constraints and communicates it to the second device (620). The first device then selects a configuration k (630) and retrieves the associated probability table (640). This table is then used in the entropic coder to encode the features (650), which are sent to the second device (660). The device can then reevaluate its configuration if the conditions change, for example the computational resources available. This communication can be performed in multiple ways. Next, we describe two possible embodiments and list some variants.

### Bitstream Embodiment

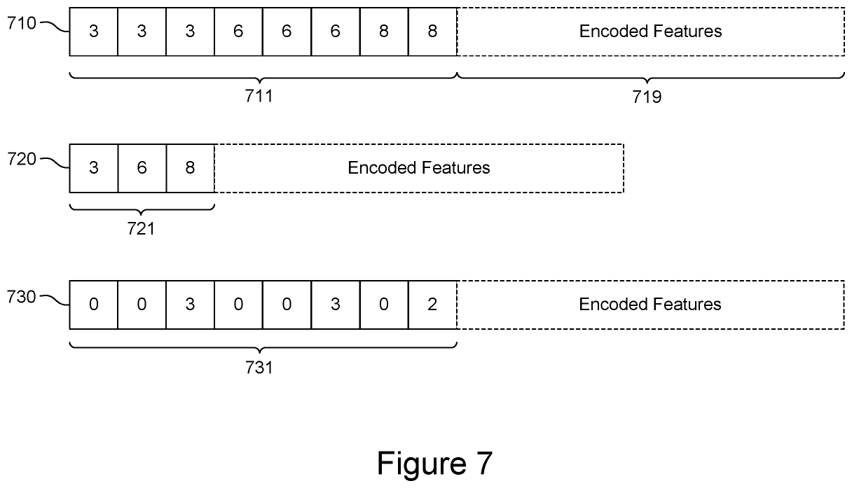

In this first embodiment, the mapping is communicated to the second device by updating the bitstream used to encode the features. There are multiple approaches possible to do so. FIG. 7 illustrates a few examples. The illustration is based on the mapping in FIG. 4. The first possibility (710) lists the mapping explicitly in the bitstream in the first part of the bitstream (711) by including the index i of the table associated to each possible configuration k associated to the flexible network, ordered by increasing k. Any other order is possible. In this example and all others, the mapping is included in the bitstream before the encoding features and any other information (719), but any position is possible. If tables are only mapped to configuration with a lower index than the table and a table is not mapped to configurations with an index lower than another table that is mapped, the resulting bitstream (720) can then only include the index of the tables that are used (721). With the same conditions, another implementation could include in the bitstream (730) the number of times a table is used (731). This information could also be directly included in the bitstream or encoded differently, for example by an entropy coder.

Another possible embodiment is to communicate the mapping on the fly during execution. In other words, the first device when communicate the table used in a given configuration k the first time this configuration is used. Yet another possibility is to allow the first device to communicate the table it uses at any time. This could be done either with or without an initial mapping. If a mapping has been defined, different conventions are possible. For example, the table could be used until another table is chosen and communicated by device 1, until a configuration change or for a given number of transmitted feature vectors.

### Device Embodiment

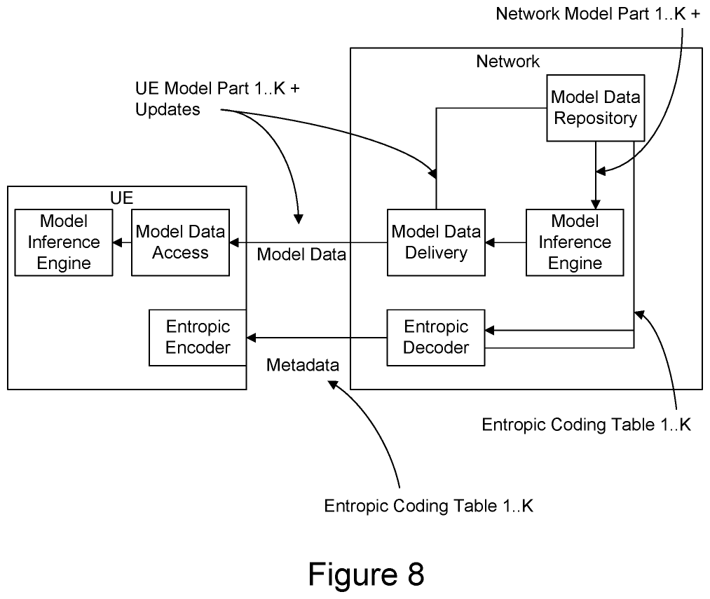

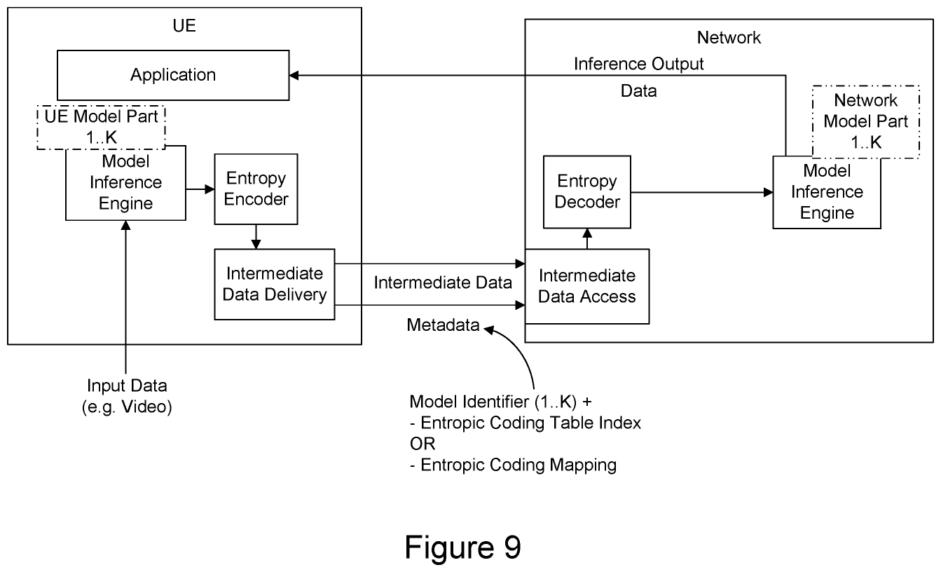

FIGS. 8 and 9 show an embodiment according to the described aspects where the data source comes from a UE (device 1) and inference is split between the UE and the network (device 2). FIG. 8 depicts the configuration phase where model data and additional model metadata are configured and sent before the running phase. FIG. 9 shows the running phase where the UE produces intermediate data to the Network sid

In other embodiment, the network can be the source of the data and as such the intermediate data will flow from the Network side to the UE side

During the configuration phase FIG. 8, the network sends the mapping tables (t₁, . . . t_{K}) together with the different flexible model subsets or configurations (1, . . . , K) to the UE.
During the running phase, the UE
1. Estimates the network and UE conditions,
2. Selects the adapted model subset among the different model configurations
3. Selects the corresponding entropy distribution table.
4. Executes the UE inference from the selected model
5. Processes the input content and produces a intermediate features
6. Encodes the intermediate features using the corresponding entropy distribution table into a bitstream
7. Segments the intermediate bitstream into different intermediate data delivery segments
8. Distributes data segments and metadata indicating the model identifier and/or the or the entropy distribution table identifier to apply on the segments to the network
   Conversely, the network:
1. Receives the data segments and the metadata indicating the model identifier and the entropy distribution table identifier to apply on the received segments.
2. Reconstructs the bitstream from the data segments.
3. Selects the network model from the model identifier.
4. Selects the entropy distribution table from the entropy distribution table identifier.
5. Decodes the bitstream using the corresponding entropy distribution table.
6. Executes the network inference from the selected network subset for the recovered intermediate features
7. Produces the inference output and sends it back to the UE.

In an embodiment, the UE may send the entropy distribution table identifier when it changes

In another embodiment, The UE may send the entropy distribution table use for the entropy encoder instead of an index. $

In another embodiment, the UE sends the chosen mapping to the network rather than table identifiers.

### Variants:

It is straightforward to apply the general aspects to the case where, in addition to the auto-encoder, other or all elements of the neural networks are flexible.

A particular case of these aspects is when the neural network is used for image or video compression. This type of compression is often called “end-to-end” neural compression. In that case, the input is typically the image or video, the features transmitted are an encoding of an image or video and the output of the network is the decoded image/video. The first device is the encoder, and the second device is the decoder.

The entropy distribution can also be encoded by a neural network.

As described here, the general aspects can be applied to end-to-end compression. Flexible models are investigated in the academic literature in that context. End-to-end compression techniques are currently being considered by several working groups in MPEG. End-to-end compression techniques are also investigated by different research groups in several companies. The state of the art is evolving quickly and in terms of rate-distortion trade-offs those techniques start to be competitive with traditional compression. Neural network-based compression is also being used to enhance traditional compression. The described embodiments apply to any flexible neural architecture. Therefore, it has the potential to be useful both for end-to-end video compression and to improve neural network models used in traditional compression, even as state-of-the-art architectures change.

The described aspects can also be applied to split inference, which is currently being standardized by 3GPP in document S4-221160.

Split inference is also studied in the context of the MPEG Video Coding for Machine group.

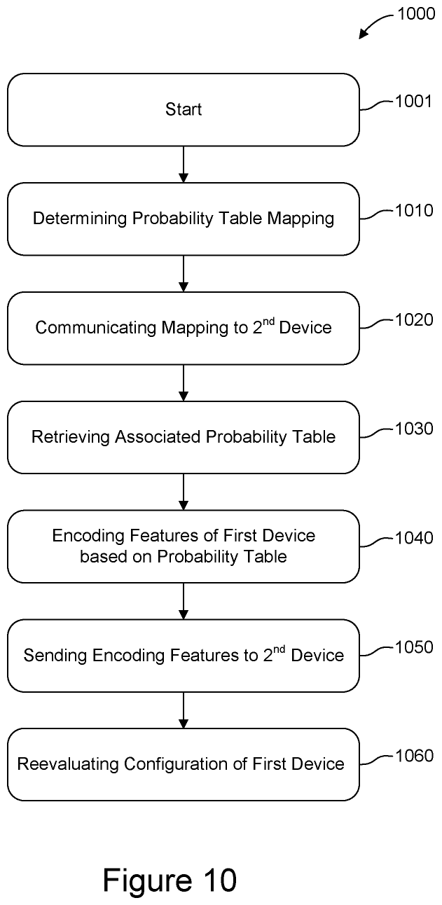

One embodiment of a method 1000 for encoding/decoding video data is shown in FIG. 10. The method commences at Start bock 1001 and proceeds to block 1010 for determining a probability table mapping by a first neural device based on constraints for an image. Control proceeds from block 1010 to block 1020 for communicating the probability table mapping to a second neural device. Control proceeds from block 1020 to block 1030 for retrieving an associated probability table based on a configuration by the first neural device. Control proceeds from block 1030 to block 1040 for encoding features of the first neural device based on the associated probability table. Control proceeds from block 1040 to block 1050 for sending the encoded features to the second neural device. Control proceeds from block 1050 to block 1060 for reevaluating the configuration of the first neural device.

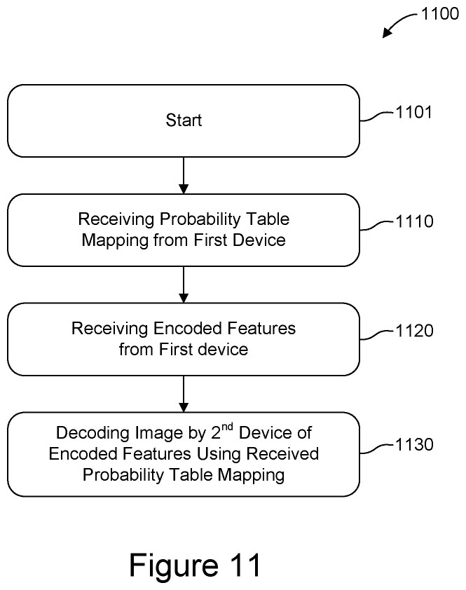

One embodiment of a method 1100 for decoding video data is shown in FIG. 11. The method commences at Start block 1101 and proceeds to block 1110 for receiving probability table mapping from a first neural device. Control proceeds from block 1110 to block 1120 for receiving encoded features from the first neural device. Control proceeds from block 1120 to block 1130 for decoding by a second device the encoded features using the received probability table mapping to generate an image.

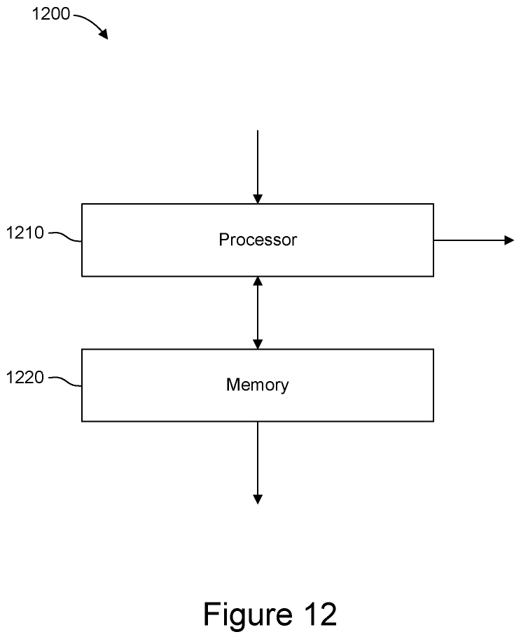

FIG. 12 shows one embodiment of an apparatus 1200 for compressing, encoding or decoding video using the aforementioned methods. The apparatus comprises Processor 1210 and can be interconnected to a memory 1220 through at least one port. Both Processor 1210 and memory 1220 can also have one or more additional interconnections to external connections.

Processor 1210 is also configured to either insert or receive information in a bitstream and, either compressing, encoding, or decoding using the aforementioned methods.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

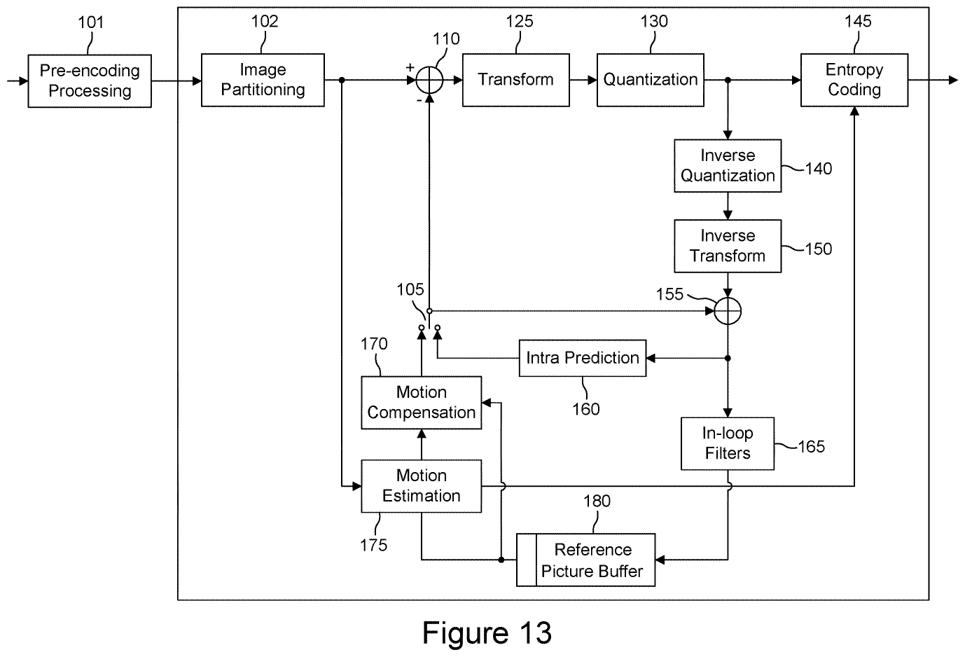

The aspects described and contemplated in this application can be implemented in many different forms. FIGS. 13, 14, and 15 provide some embodiments, but other embodiments are contemplated and the discussion of FIGS. 13, 14, and 15 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” or “reconstructed” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

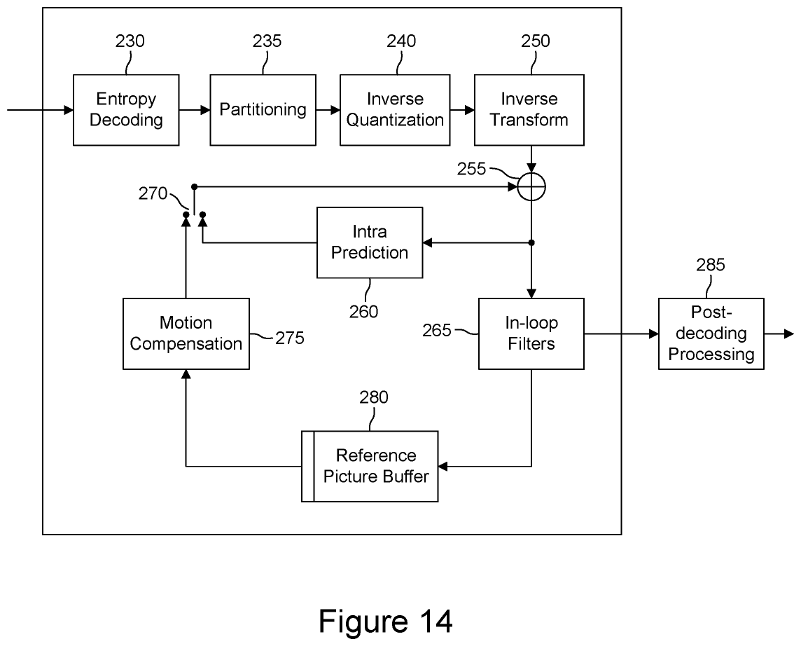

Various methods and other aspects described in this application can be used to modify modules, for example, the intra prediction, entropy coding, and/or decoding modules (160, 360, 145, 330), of a video encoder 100 and decoder 200 as shown in FIG. 13 and FIG. 14. Moreover, the present aspects are not limited to WVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 13 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 14 illustrates a block diagram of a video decoder 200. In the decoder 200, a bitstream is decoded by the decoder elements as described below. Video decoder 200 generally performs a decoding pass reciprocal to the encoding pass as described in FIG. 13. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

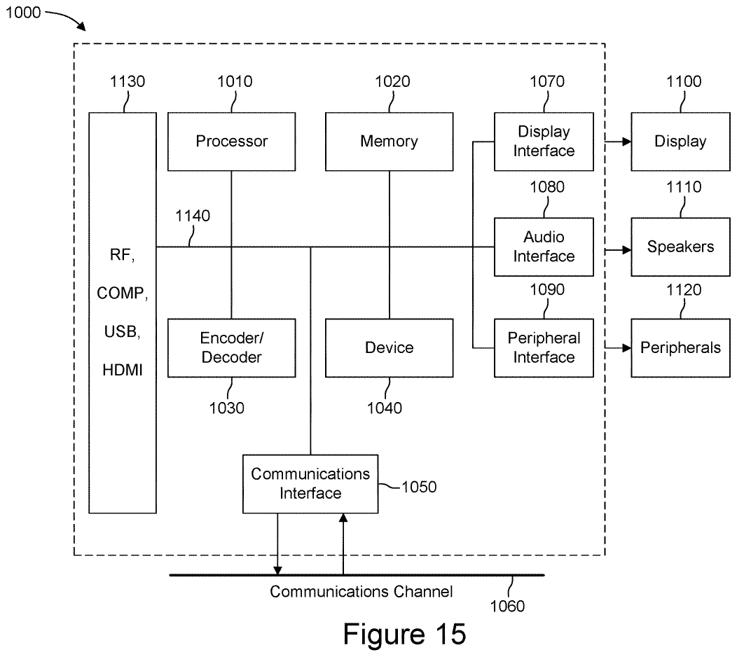

FIG. 15 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 15, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

We describe a number of embodiments, across various claim categories and types. Features of these embodiments can be provided alone or in any combination. Further, embodiments can include one or more of the following features, devices, or aspects, alone or in any combination, across various claim categories and types, including a first device comprising user equipment and a second device comprising a network.

In one embodiment, mapping information for compression of an image is communicated from a first device to a second device using bitstream data between the first and second devices.

In one embodiment, inference is split between the user equipment and a network.

The present disclosure contemplates creating and/or transmitting and/or receiving and/or decoding a bitstream or signal that includes one or more of the described syntax elements, or variations thereof.

In one embodiment, a TV, set-top box, cell phone, tablet, or other electronic device performs transform method(s) according to any of the embodiments described.

In one embodiment, a TV, set-top box, cell phone, tablet, or other electronic device performs transform method(s) determined according to any of the embodiments described, and displays (e.g., using a monitor, screen, or other type of display) a resulting image.

In one embodiment, a TV, set-top box, cell phone, tablet, or other electronic device selects, bandlimits, or tunes (e.g., using a tuner) a channel to receive a signal including an encoded image, and performs transform method(s) according to any of the embodiments described.

In one embodiment, a TV, set-top box, cell phone, tablet, or other electronic device receives (e.g., using an antenna) a signal over the air that includes an encoded image, and performs transform method(s).

1. A method, comprising:
determining a probability table mapping by a first neural device based on a plurality of constraints for an image, wherein the probability table mapping adaptively associates entropy probabilities with configurations of the first neural device, and the plurality of constrains comprise computational power, memory, and energy;
communicating said probability table mapping to a second neural device;
retrieving an associated probability table based on a configuration by the first neural device;
encoding features of the first neural device based on the associated probability table;
sending said encoded features to the second neural device; and,
reevaluating the configuration of the first neural device.

2. An apparatus, comprising:
memory, and
a processor, configured to perform:
determining a probability table mapping by a first neural device based on a plurality of constraints for an image, wherein the probability table mapping adaptively associates entropy probabilities with configurations of the first neural device, and the plurality of constrains comprise computational power, memory, and energy;
communicating said probability table mapping to a second neural device;
retrieving an associated probability table based on a configuration by the first neural device;
encoding features of the first neural device based on the associated probability table;
sending said encoded features to the second neural device; and,
reevaluating the configuration of the first neural device.

3. A method, comprising:
receiving probability table mapping from a first neural device, wherein the probability table mapping adaptively associates entropy probabilities with configurations of the first neural device;
receiving encoded features from the first neural device; and,
decoding by a second device said encoded features using said received probability table mapping to generate an image.

4. An apparatus, comprising:
memory, and
a processor, configured to perform:
receiving probability table mapping from a first neural device, wherein the probability table mapping adaptively associates entropy probabilities with configurations of the first neural device;
receiving encoded features from the first neural device; and,
decoding by a second device said encoded features using said received probability table mapping to generate an image.

5. The method of claim 1, wherein said probability table mapping is communicated from a first device within a coded bitstream.

6. The method of claim 5, wherein said probability table mapping comprises an index associated with possible configurations, or a number of times a respective table is used.

7. The method of claim 5, wherein said probability table mapping is communicated on the fly during execution.

8. The apparatus of claim 2, wherein the first device is user equipment and said second device is a network.

9. The apparatus of claim 8, wherein said network is a source of data to said user equipment.

10. The apparatus of claim 8, wherein the user equipment sends information comprising an entropy distribution table identifier, an entropy distribution table usage, or a chosen mapping to said network.

11. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of a video block.

12. A non-transitory computer readable medium containing data content generated according to the method of claim 1, for playback using a processor.

13. (canceled)

14. A computer program product comprising instructions which, when the program is executed by a computer, cause the computer to carry out the method of claim 3.

15. A non-transitory computer readable medium containing data content comprising instructions to perform the method of claim 1.

16. The method of claim 3, wherein said probability table mapping is communicated from a first device within a coded bitstream.

17. The method of claim 16, wherein said probability table mapping comprises an index with possible configurations, or a number of times a respective table is used.

18. The method of claim 16, wherein said probability table mapping is communicated on the fly during execution.

19. The apparatus of claim 4, wherein the first device is user equipment and said second device is a network.

20. The apparatus of claim 19, wherein said network is a source of data to said user equipment.

21. The apparatus of claim 19, wherein the user equipment sends information comprising an entropy distribution table identifier, an entropy distribution table usage, or a chosen mapping to said network.
